(19) United States
(12) Patent Application Publication
(10) Pub. No.: US 2024/0430866 A1
(43) Pub. Date: Dec. 26, 2024

(54) METHOD FOR RESOURCE ALLOCATION

(71) Applicant: ZTE CORPORATION, Shenzhen (CN)

(72) Inventors: Jiajun XU, Shenzhen (CN); Jun XU, Shenzhen (CN); Bo DAI, Shenzhen (CN); Mengzhu CHEN, Shenzhen (CN); Jianqiang DAI, Shenzhen (CN); Xiaoying MA, Shenzhen (CN); Hong TANG, Shenzhen (CN)

(73) Assignee: ZTE CORPORATION, Shenzhen (CN)

(21) Appl. No.: 18/732,802

(22) Filed: Jun. 4, 2024

Related U.S. Application Data
(63) Continuation of application No. PCT/CN2022/088222, filed on Apr. 21, 2022.

(51) Int. Cl. H04W 72/044; H04W 72/231

(52) U.S. Cl. CPC H04W 72/044; H04W 72/231

(57) ABSTRACT

Method, device and computer program product for wireless communication are provided. A method includes: receiving, by a wireless communication terminal from a wireless communication node, a control signal; determining, by the wireless communication terminal, a first set of information according to the control signal; and performing, by the wireless communication terminal, a transmission of uplink data or a reception of downlink data based on transmission occasions according to the first set of information.

### CROSS-REFERENCE TO RELATED PATENT APPLICATIONS

This application is a Continuation of PCT Application No. PCT/CN2022/088222, filed Apr. 21, 2022, incorporated herein by reference in its entirety.

### TECHNICAL FIELD

This document is directed generally to wireless communications, in particular to 5th generation (5G) or 6th generation (6G) wireless communications.

### BACKGROUND

In beyond 5G and 6G communication, one of the promising services is characterized by quasi-periodicity, large and various data amount and stringent latency requirement, including e.g., extended reality (XR) service. In some approaches, granted transmission, including configured grant (CG) and semi-persistent scheduling (SPS), is capable of conveying periodic data by preconfigured resource without grant request and excessive power consumption. However, owing to the service characteristic of quasi-periodicity as well as large and various data amount, the SPS and CG might not be able to support this kind of service.

### SUMMARY

The present disclosure relates to methods, devices, and computer program products for configuring multiple resources.

One aspect of the present disclosure relates to a wireless communication method. In an embodiment, the wireless communication method includes: receiving, by a wireless communication terminal from a wireless communication node, a control signal; determining, by the wireless communication terminal, a first set of information according to the control signal; and performing, by the wireless communication terminal, a transmission of uplink data or a reception of downlink data based on transmission occasions according to the first set of information.

Another aspect of the present disclosure relates to a wireless communication method. In an embodiment, the wireless communication method includes: transmitting, by a wireless communication node to a wireless communication terminal, a control signal to allow the wireless communication terminal to determine a first set of information according to the control signal and perform a transmission of uplink data or a reception of downlink data based on transmission occasions according to the first set of information.

Another aspect of the present disclosure relates to a wireless communication terminal. In an embodiment, the wireless communication terminal includes a communication unit and a processor. The processor is configured to: receive, from a wireless communication node, a control signal; determine a first set of information according to the control signal; and perform a transmission of uplink data or a reception of downlink data based on transmission occasions according to the first set of information.

Another aspect of the present disclosure relates to a wireless communication node. In an embodiment, the wireless communication node includes a communication unit and a processor. The processor is configured to: transmit, to a wireless communication terminal, a control signal to allow the wireless communication terminal to determine a first set of information according to the control signal and perform a transmission of uplink data or a reception of downlink data based on transmission occasions according to the first set of information.

Various embodiments may preferably implement the following features:

Preferably or in some embodiments, the control signaling is at least one of: Radio Resource Control, RRC, signaling, Medium Access Control Control Element, MAC CE, signaling, or Downlink Control Information, DCI, signaling.

Preferably or in some embodiments, the DCI signaling comprises at least one block set, the block set comprises one or more blocks, each block is associated with at least one of: one or more configurations, one or more configuration sets, one or more user equipments, one or more serving cells, or one or more serving cell groups.

Preferably or in some embodiments, location information of the blocks in the DCI signaling is determined by at least one of one or more high layer parameters or a bit width of one or more information fields.

Preferably or in some embodiments, the DCI signaling includes at least one of the following re-interpreted information fields: Hybrid Automatic Repeat Request, HARQ, Process Number; Redundancy version; Time domain resource assignment; Frequency domain resource assignment; Modulation and coding scheme, MCS; Downlink assignment index; Transmit Power Control, TPC, command for scheduled Physical Uplink Control Channel, PUCCH; or Virtual Resource Blocks to Physical Resource Blocks, VRB-to-PRB, mapping.

Preferably or in some embodiments, at least one of the information fields of the DCI signaling is re-interpreted in response to at least one of: one or more high layer parameters; or at least one of the following information fields is set to a predefined value: HARQ Process Number; Redundancy version; Time domain resource assignment; Frequency domain resource assignment; MCS; Downlink assignment index; TPC command for scheduled PUCCH; or VRB-to-PRB mapping.

Preferably or in some embodiments, the first set of information comprises first information for determining the transmission occasions for one or more configurations, and the first information comprises at least one of:
a length information of a duration;
a number information of configurations;
a configuration set information;
a periodicity information;
a valid or invalid indication; or
a number of scheduled resources.

Preferably or in some embodiments, there are one or more transmission occasions in the duration, and the duration is periodic.

Preferably or in some embodiments, periodicity of the transmission occasions in the duration and/or the periodicity of the duration is determined by the periodicity information.

Preferably or in some embodiments, the length information of the duration in the first information determines the length of the duration, and the length information comprises: a number of symbols; a number of slots; or a number of HARQ process identifiers.

Preferably or in some embodiments, the transmission occasions in the duration is determined by the valid or invalid indication, and the indication comprises: a valid or invalid indication of symbols; a valid or invalid indication of slots; or a valid or invalid indication of HARQ process identifiers.

Preferably or in some embodiments, the valid or invalid indication is at least one of one or more bitmaps, or one or more start and length Indicator values, SLIVs.

Preferably or in some embodiments, the length of the bitmap is associated with the length of the duration.

Preferably or in some embodiments, a bit in one or more bitmaps indicates a number of transmission occasions or a number of scheduled resource, wherein the scheduled resource comprises at least one of a symbol, a slot, a HARQ process identifier or a part of a bandwidth of a symbol, slot, or HARQ process identifier to determine the transmission occasions.

Preferably or in some embodiments, the maximum value of the SLIVs is associated with the length of the duration.

Preferably or in some embodiments, the SLIVs determine the starting transmission occasions or scheduled resources and the length of transmission occasions or scheduled resources in the duration.

Preferably or in some embodiments, the configuration set comprises one or more configurations, and the number of configurations is associated with number information of configurations, wherein the configurations comprise one or more transmission occasions.

Preferably or in some embodiments, the first set of information comprises second information for determining a time domain resource assignment for one or more transmission occasions, and the second information comprises at least one of: time domain information of a first transmission occasion of the transmission occasions in the duration; or time domain information of the transmission occasions in the duration.

Preferably or in some embodiments, the second information is time domain information of the first transmission occasion of the transmission occasions in the duration, and the time domain information of remaining transmission occasions in the duration is determined by the first transmission occasion.

Preferably or in some embodiments, the second information is time domain information of the transmission occasions in the duration, and the time domain information is at least one of: one or more time domain pattern identifiers, wherein a time domain pattern comprises one or more SLIVs.

Preferably or in some embodiments, one of the time domain pattern identifiers indicates the time domain information of the transmission occasions in the duration.

Preferably or in some embodiments, one of time domain pattern identifiers indicates the time domain information of one of the transmission occasions in the duration.

Preferably or in some embodiments, the first set of information comprises third information for determining a frequency domain resource assignment for one or more transmission occasions, and the third information comprises at least one of: frequency domain information of a first transmission occasion of the transmission occasions in the duration; or frequency domain information of the transmission occasions in the duration.

Preferably or in some embodiments, the third information is frequency domain information of the first transmission occasion of the transmission occasions in the duration, and the frequency domain information of remaining transmission occasions in the duration is determined by the first transmission occasion.

Preferably or in some embodiments, the third information is frequency domain information of the transmission occasions in the duration, and the frequency domain information is at least one of: one or more frequency domain pattern identifiers, wherein a frequency domain pattern comprises one or more Resource Indicator Values, RIVs.

Preferably or in some embodiments, one of the frequency domain pattern identifiers indicates the frequency domain information of transmission occasions in the duration.

Preferably or in some embodiments, one of the frequency domain pattern identifiers indicates the time domain information of one of the transmission occasions in the duration.

Preferably or in some embodiments, the first set of information comprises fourth information for determining a modulation and coding scheme level for one or more transmission occasions, and the fourth information comprises at least one of: modulation and coding scheme, MCS, tables; an MCS level; or a delta MCS level.

Preferably or in some embodiments, the fourth information is the MCS level of a first transmission occasion of the transmission occasions in the duration, and the MCS level of remaining transmission occasions in the duration is determined by the first transmission occasion.

Preferably or in some embodiments, the fourth information is one or more MCS levels of the transmission occasions in the duration.

Preferably or in some embodiments, the delta MCS level is associated with an MCS level of a first transmission occasion, or an MCS level of a former transmission occasion.

Preferably or in some embodiments, the first set of information comprises fifth information for determining activations of one or more transmission occasions, and the fifth information comprises at least one of: an activation indication, an activation type indication, a configuration set identifier, or a configuration identifier.

Preferably or in some embodiments, the activation type indication determines the fifth information is for single transmission occasion activation or multiple transmission occasion activation, and the activation type indication comprises at least one of: a bit flag, a re-interpreted information field, a configuration index, or an interval between the control signal and a first transmission occasion.

Preferably or in some embodiments, the configuration set identifier determines which configuration set is activated.

Preferably or in some embodiments, the first set of information comprises sixth information for determining deactivations of one or more transmission occasions, and the sixth information comprises at least one of: a deactivation indication, a deactivation type indication, a configuration set identifier, or a configuration identifier.

Preferably or in some embodiments, the deactivation type indication determines the sixth information is for single transmission occasion activation or multiple transmission occasion deactivation, and the deactivation type indication comprises at least one of: a bit flag, a re-interpreted information field, a configuration index, or an interval between the control signal and a first transmission occasion.

Preferably or in some embodiments, the configuration set identifier determines which configuration set is deactivated.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows an SPS configuration pattern (i.e., one transmission occasion) according to an embodiment of the present disclosure.

FIG. 2 shows a CG configuration pattern (i.e., one transmission occasion) according to an embodiment of the present disclosure.

FIGS. 3 to 21 show resource indication methods (e.g., with multiple transmission occasions) according to embodiments of the present disclosure.

FIG. 22 shows an example of a schematic diagram of a wireless communication terminal according to an embodiment of the present disclosure.

FIG. 23 shows an example of a schematic diagram of a wireless communication node according to an embodiment of the present disclosure.

One aspect of the discourse provides a resource allocation method for configuring multiple transmission occasions for uplink transmission and for downlink transmission.

### DETAILED DESCRIPTION

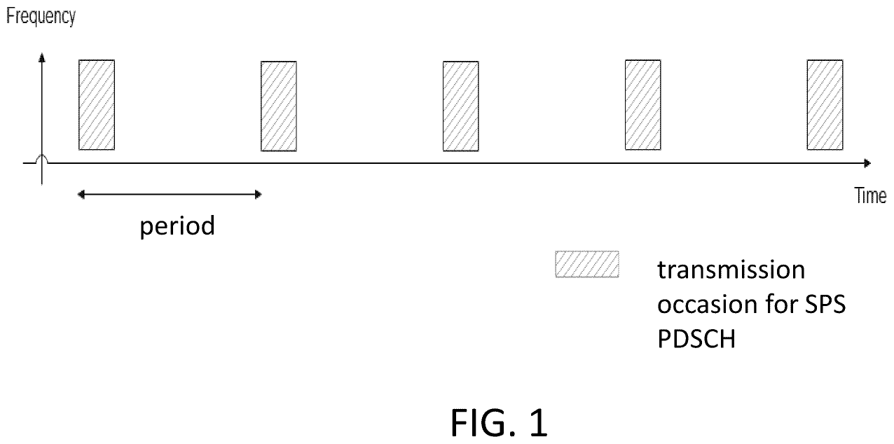

FIG. 1 shows an SPS configuration pattern according to an embodiment of the present disclosure.

For the semi-persistent scheduling (SPS) transmission, the gNB transmits a Radio Resource Control (RRC) signaling to the UE (user equipment) including an SPS configuration, which includes the periodicity, the modulation and coding scheme (MCS) level, information of the physical uplink control channel (PUCCH) resource and so on. Then, the gNB transmits an activation DCI to the UE to activate the SPS configuration. The gNB transmits data via the physical downlink shared channel (PDSCH) based on the periodicity determined by the SPS configuration without monitoring the physical downlink control channel (PDCCH). While the gNB transmits a release DCI to stop transmitting the pre-scheduled PDSCH, the SPS configuration is release.

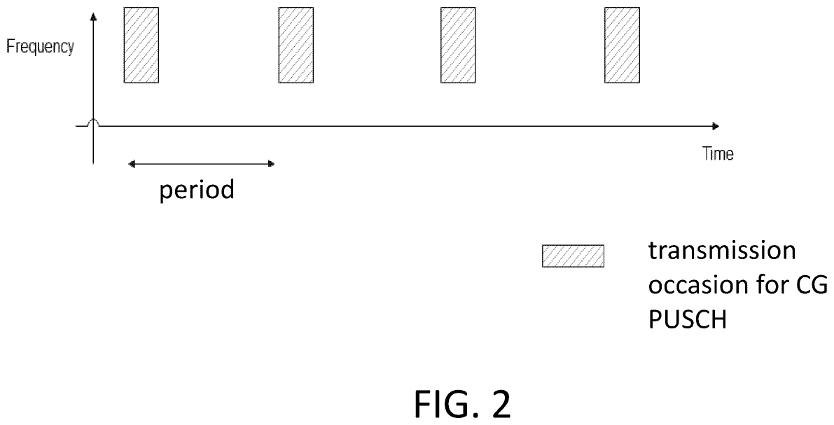

FIG. 2 shows a CG configuration pattern according to an embodiment of the present disclosure.

In an embodiment, uplink configured grant (CG) transmission includes two types.

For the type-1 CG, the user equipment (UE) receives a radio resource control (RRC) signaling (e.g., configuredGrantConfig) from the gNB, where the periodicity, the resource assignment information, modulation and the coding scheme (MCS) table/level and other scheduling information are included. Then, after an offset determined by configuredGrantConfig, the type-1 CG is activated. The UE transmits data via physical uplink shared channel (PUSCH) based on the periodicity determined by configuredGrantConfig without the grant request. While the UE receives a release downlink control information (DCI) to stop transmitting the data via the granted PUSCH, the type-1 CG is released.

For the type-2 CG, the UE also receives an RRC signaling (e.g., configuredGrantConfig) from the gNB. Then, an activation DCI is received by the UE from the gNB to activate the type-2 CG. The UE transmits data via PUSCH based on the periodicity determined by configuredGrantConfig without the grant request. While the UE receives a release DCI to stop transmitting data via the granted PUSCH, the type-2 CG is released.

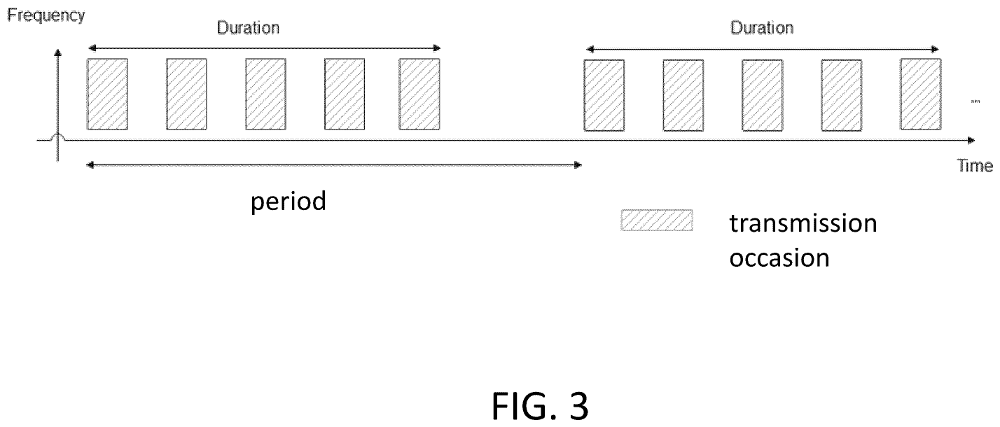

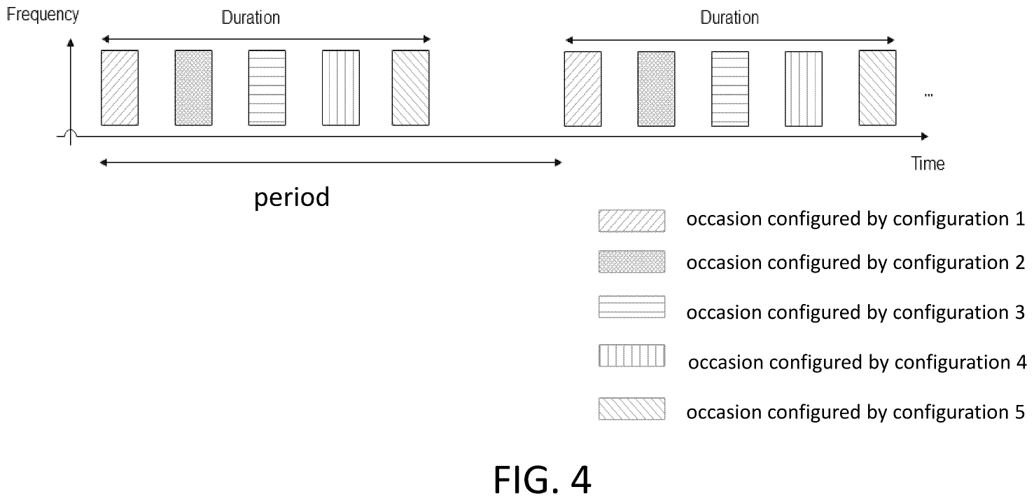

FIGS. 3 and 4 show different configuration patterns according to an embodiment of the present disclosure.

In order to have more transmission occasions for packets with large data and mitigate the jitter impact on the offset between packet arrival and preconfigured resource, multiple transmission occasions are configured by a single configuration (see FIG. 3) or by a combination of multiple configurations (see FIG. 4). With such a configuration, data can be transmitted in time regardless of the negative effect of jitter impact.

In an embodiment, a method includes receiving, by a wireless communication terminal from a wireless communication node, a control signal; determining, by the wireless communication terminal, a first set of information according to the control signal; and performing, by the wireless communication terminal, a transmission of uplink data or a reception of downlink data based on transmission occasions according to the first set of information.

In the paragraphs below, details of the control signal (also referred to control signaling herein) and the first set of information in some embodiments are described, but the present disclosure is not limited thereto.

In some embodiments, the control signaling includes at least one of the following: RRC signaling; MAC CE (Medium Access Control Control Element) signaling; and/or DCI (Downlink Control Information) signaling.

For uplink configured grant transmission:
RRC signaling is configuredGrantConfig,
MAC CE signaling is:
   BSR (Buffer Status reporting) signaling,
   Configure Grant Confirmation signaling,
   Multiple Configured Grant Confirmation signaling,
   Truncated Sidelink BSR,
   Sidelink BSR,
   LBT (Listen Before Talk) failure (four octets),
   LBT failure (one octet),
   BFR (Beam Failure Recovery) (four octet Cᵢ),
   BFR (one octet Cᵢ),
   Truncated BFR (one octet Cᵢ),
   Truncated BFR (four octets Cᵢ),
   Recommended bit rate query,
   Multiple Entry PHR (Power Headroom Report) (four octets Cᵢ),
   Multiple Entry PHR (one octet Cᵢ),
   Single Entry PHR,
   C-RNTI,
   Short Truncated BSR,
   Long Truncated BSR,
   Short BSR,
   Long BSR,
   Desired Guard Symbols,
   Pre-emptive BSR, or
   new designed MAC CE indicated by the reserved codepoint/index of LCID (Logical Channel ID)/eLCID (extended LCID) values.

E.g., MAC CE signaling “Configured grant activation/deactivation” is indicated by the reserved codepoint/index 35-44, 47, 63 of LCID values,

E.g,. MAC CE signaling “Configured grant activation/deactivation” is indicated by the reserved codepoint/index 0-249/64-313 of eLCID values.
DCI signaling is DCI format 0_0, DCI format 0_1, DCI format 0_2, or DCI format 2.
In some cases, the control signaling is: RRC signaling and DCI signaling; RRC signaling and MAC CE; or RRC signaling, MAC CE, and DCI signaling.

For downlink SPS transmission:
RRC signaling is SPS-config.
MAC CE signaling is:
   Recommended bit rate,
   SP (Semi-persistent) ZP (zero power) CSI-RS (Channel Status Information Reference Signal) Resource Set Activation/Deactivation,
   PUCCH (physical uplink control channel) spatial relation Activation/Deactivation,
   SP SRS (sounding reference signal) Activation/Deactivation,
   PUCCH spatial relation Activation/Deactivation,
   SP SRS Activation/Deactivation,
   TCI (Transmission Configuration Indicator) State Indication for UE-specific PDCCH (physical downlink control channel),
   TCI States Activation/Deactivation for UE-specific PDSCH (physical downlink shared channel),
   Aperiodic CSI Trigger State Subselection,
   SP CSI-RS/CSI-IM (Channel Status Information Interference Measurement) Resource Set Activation/Deactivation,
   SCell Activation/Deactivation (four octets),
   SCell Activation/Deactivation (one octet),
   Long DRX (discontinuous reception) Command,
   Short DRX Command,
   Timing Advance Command,
   UE Contention Resolution Identity,
   Serving Cell Set based SRS Spatial Relation Indication,
   SRS Pathloss Reference RS Update,
   Enhanced SP/AP (aperiodic) SRS Spatial Relation Indication,
   Enhanced TCI States Activation/Deactivation for UE-specific PDSCH,
   Duplication RLC (Radio Link Control) Activation/Deactivation,
   Absolute Timing Advance Command,
   SP Positioning SRS Activation/Deactivation,
   Provided Guard Symbols,
   Timing Delta, or
   new designed MAC CE indicated by the reserved codepoint/index of LCID/eLCID values.

E.g., MAC CE signaling “Semi-persistent scheduling activation/deactivation” indicated by the reserved codepoint/index 35-46, 63 of LCID values,

E.g., MAC CE signaling “Configured grant activation/deactivation” indicated by the reserved codepoint/index 0-249/64-313 of eLCID values.
DCI signaling is DCI format 1_0, DCI format 1_1, DCI format 1_2, or DCI format 2
In some cases, the control signaling is: RRC signaling and DCI signaling; RRC signaling and MAC CE; or RRC signaling, MAC CE, and DCI signaling.

In some embodiments, the DCI signaling includes at least one block set. In this case, the DCI format may be group common DCI. In some embodiments, the block set includes one or more blocks. Each block is associated with one or more configurations, one or more configuration sets, one or more user equipments, one or more serving cells, and/or one or more serving cell groups.

In some embodiments, the location information of the blocks in the DCI signaling is determined by at least one of: one or more high layer parameters and/or one or more bit width of one or more information fields.

In some embodiments, the DCI signaling conveying the blocks has at least one of the following characteristics: the DCI format, the DCI size, the RNTI (Radio Network Temporary Identifier) that scrambles the CRC (cyclic redundancy check) bits, and/or the search space set.

In some embodiments, the DCI signaling carries information described above based on the re-interpretation of at least one of the following information fields: HARQ (Hybrid Automatic Repeat Request) Process Number; Redundancy version; Time domain resource assignment; Frequency domain resource assignment; MCS (Modulation and coding scheme); Downlink assignment index; TPC (Transmit Power Control) command for scheduled PUCCH (Physical Uplink Control Channel); and/or VRB-to-PRB (Virtual Resource Blocks to Physical Resource Blocks) mapping.

In other words, in some embodiments, the DCI signaling includes at least one of the following re-interpreted information fields: Hybrid Automatic Repeat Request, HARQ, Process Number; Redundancy version; Time domain resource assignment; Frequency domain resource assignment; Modulation and coding scheme, MCS; Downlink assignment index; Transmit Power Control, TPC, command for scheduled Physical Uplink Control Channel, PUCCH; and/or Virtual Resource Blocks to Physical Resource Blocks, VRB-to-PRB, mapping.

In some embodiments, the DCI signaling carries information described above based on the re-interpretation of at least one of the information fields described above when a predefined condition is fulfilled. In an embodiment, the predefined condition includes at least one of an indication of one or more high layer parameters (e.g., via RRC signaling); and/or at least one of the following information fields is set to a predefined value (e.g., all zeros or all ones): HARQ Process Number; Redundancy version; Time domain resource assignment; Frequency domain resource assignment; MCS; Downlink assignment index; TPC command for scheduled PUCCH; and/or VRB-to-PRB mapping.

In other words, in some embodiments, at least one of the information fields of the DCI signaling is re-interpreted in response to at least one of: one or more high layer parameters; or at least one of the following information fields is set to a predefined value: HARQ Process Number; Redundancy version; Time domain resource assignment; Frequency domain resource assignment; MCS; Downlink assignment index; TPC command for scheduled PUCCH; or VRB-to-PRB mapping.

In some embodiments, the first set of information described above includes at least one of: first information, second information, third information, fourth information, fifth information, sixth information, and/or Frequency hopping, SRS resource indicator, Precoding information and number of layers, Antenna port, CBG (Code Block Group) transmission information, Beta_offset indication, PUCCH resource indicator, PDSCH-to-HARQ_feedback timing indicator, PRB (physical resource block) bundling size indicator, Rate matching indicator.

In some embodiments, the transmission occasions for the one or more configurations are determined by the first information.

In some embodiments, the first set of information comprises first information for determining the transmission occasions for one or more configurations, and the first information comprises at least one of: a length information of a duration; a number information of configurations; a configuration set information; a periodicity information; a valid or invalid indication; and/or a number of scheduled resources.

In some embodiments, there are one or more transmission occasions in the duration, and each the duration is periodic (see FIG. 3 and FIG. 4). In some embodiments, periodicity of the transmission occasions in the duration and/or the periodicity of the duration is determined by the periodicity information.

In some embodiments, the length information of the duration in the first information determines the length of the duration, and the length information comprises: a number of symbols; a number of slots; and/or a number of HARQ process identifiers.

In some embodiments, the transmission occasions in the duration is determined by the valid or invalid indication, and the indication comprises: a valid or invalid indication of symbols; a valid or invalid indication of slots; and/or a valid or invalid indication of HARQ process identifiers.

In some embodiments, the valid or invalid indication is at least one of one or more bitmaps, and/or one or more start and length Indicator values, SLIVs. the length of the bitmap is associated with the length of the duration. In some embodiments, a bit in one or more bitmaps indicates a number of transmission occasions or a number of scheduled resources, wherein the scheduled resource comprises at least one of a symbol, a slot, a HARQ process identifier and/or a part of a bandwidth of a symbol, slot, and/or HARQ process identifier to determine the transmission occasions. In some embodiments, the maximum value of the SLIVs is associated with the length of the duration. In some embodiments, the SLIVs determine the starting transmission occasions or scheduled resources and the length of transmission occasions or scheduled resources in the duration.

The first information includes: ‘a length information of a duration’, ‘a valid or invalid indication’ and/or ‘a periodicity information’ determined by the control signaling.

1. The ‘a length information of a duration’ is an integer indicating the number of symbols, while ‘a valid or invalid indication’ is a bitmap. In this case, the bitmap indicates the transmission occasions. The ‘a periodicity information’ includes the periodicity of the duration. This case is for uplink configured grant.

E.g., NrofSymbol determines the length of duration, and SymbolUsage determines the valid symbols in the duration.

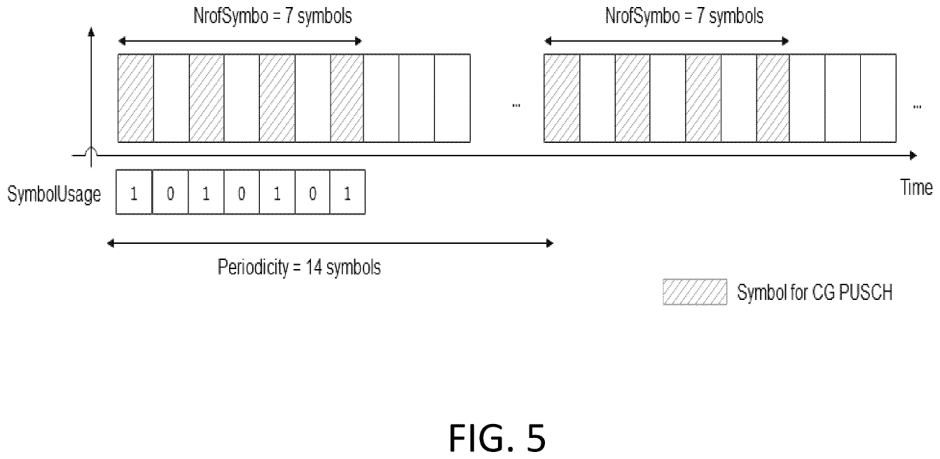

E.g., NrofSymbol is set to 7. While SymbolUsage is set to ‘1010101’. And the periodicity is set to ‘sym1×14’. The pattern is configured as shown in FIG. 5.

In this case, the N-th transmission occasion burst is expressed as:

$$[ ( SFN \times numberOfSlotsPerFrame \times numberOfSymbolsPerSlot ) + ( slot number i n the frame \times numberOfSymbolsPerSlot ) + symbol number in the slot ] = ( timeReferenceSFN \times numberOfSlotsPerFrame \times numberOfSymbolsPerSlot + timeDomainOffset \times numberOfSymbolsPerSlot + S + N \times periodicity ) modulo ( 1024 \times numberOfSlotsPerFrame \times numberOfSymbolsPerSlot ) . or$$

$$[ ( SFN \times numberOfSlotsPerFrame \times numberOfSymbolsPerSlot ) + ( slot number in the frame \times numberOfSymbolsPerSlot ) + symbol number in the slot ] = [ ( {SFN}_{start time} \times numberOfSlotsPerFrame \times numberOfSymbolsPerSlot + {slot}_{start time} \times numberOfSymbolsPerSlot + {symbol}_{start time} ) + N \times periodicity ] modulo ( 1024 \times numberOfSlotsPerFrame \times numberOfSymbolsPerSlot ) .$$

The parameter periodicity is the periodicity of Type-1 CG or Type-2 CG, and timeDomainOffset denotes offset of a resource with respect to SFN=timeReferenceSFN in time domain. The parameter timeReferenceSFN is SFN used for determination of the offset of a resource in time domain. The parameter numberOfSlotsPerFrame denotes the number of slots in per radio frame and numberOfSymbolsPerSlot denotes the number of symbols in per slot. S is the start symbol location of the duration.

A transmission occasion burst includes one or more transmission occasions in the duration, the formula determines the first transmission occasion is each transmission occasion burst.

2. The ‘a length information of a duration’ is an integer indicating the number of symbols, while ‘a valid or invalid indication’ is a start and length indication value. In this case, the SLIV determines the transmission occasions. The ‘a periodicity information’ includes the periodicity of the duration. This case is for uplink configured grant.

The start and length indication value indicates the starting valid symbol location S and the length of valid symbol L. One of the mapping relationship between SLIV and S, L is as the following:

```
if (L−1) ≤ NrofSymbol/2, then
  SLIV = NrofSymbol ·(L−1) + S ;
else
  SLIV = NrofSymbol ·(NrofSymbol −L+1) + (NrofSymbol −1−S)
where 0 ≤ L ≤ NrofSymbol
```

NrofSymbol determines the length of duration, which SymbolUsage determines the valid symbols in the duration.

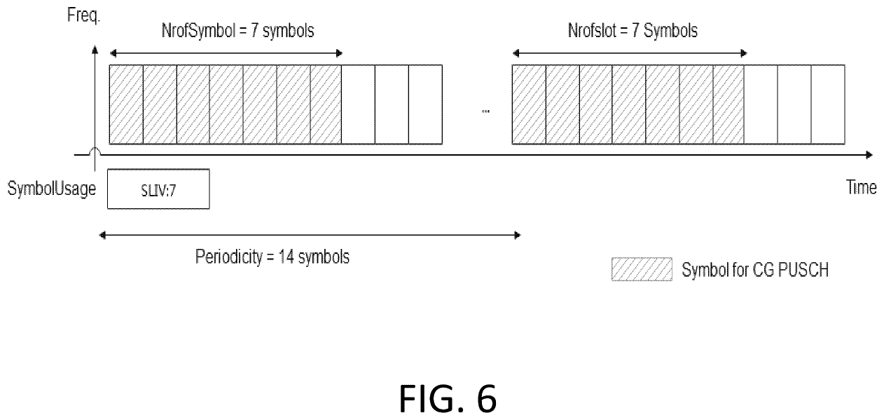

NrofSymbol is set to 7. While SymbolUsage is set to 13, which means the start symbol in the duration determined by NrofSymbol is the first symbol of the duration and the length of valid symbol is 7. And the periodicity is set to ‘sym1×14’. The pattern is configured as illustrated in FIG. 6.

In some embodiments, the N-th transmission occasion for CG is expressed as:

$$[ ( SFN \times numberOfSlotsPerFrame \times numberOfSymbolsPerSlot ) + ( slot number in the frame \times numberOfSymbolsPerSlot ) + symbol number in the slot ] = ( timeReference SFN \times numberOfSlotsPerFrame \times numberOfSymbolsPerSlot + timeDomainOffset \times numberOfSymbolsPerSlot + S + [ mod ( N , L ) ] + floor ( N / L ) \times periodicity ) \\ modulo ( 1024 \times numberOfSlotsPerFrame \times numberOfSymbolsPerSlot ) or$$

$$[ ( SFN \times numberOfSlotsPerFrame \times numberOfSymbolsPerSlot ) + ( slot number in the frame \times numberOfSymbolsPerSlot ) + symbol number in the slot ] = [ ( {SFN}_{start time} \times numberOfSlotsPerFrame \times numberOfSymbolsPerSlot + {slot}_{start time} \times numberOfSymbolsPerSlot + {symbol}_{start time} + [ mod ( N , L ) ] ) + floor ( N / L ) \times periodicity ] modulo \\ ( 1024 \times numberOfSlotsPerFrame \times numberOfSymbolsPerSlot )$$

S is the start symbol location of the duration and L denotes the length of valid symbol. The formula determines each transmission occasion.

In some embodiments, the N-th transmission occasion for CG is expressed as:

$$[ ( SFN \times numberOfSlotsPerFrame \times numberOfSymbolsPerSlot ) + ( slot number in the frame \times numberOfSymbolsPerSlot ) + symbol number in the slot ] = ( timeReferenceSFN \times numberOfSlotsPerFrame \times numberOfSymbolsPerSlot + timeDomainOffset \times numberOfSymbolsPerSlot + S + N \times periodicity ) modulo ( 1024 \times numberOfSlotsPerFrame \times numberOfSymbolsPerSlot ) or$$

$$[ ( SFN \times numberOfSlotsPerFrame \times numberOfSymbolsPerSlot ) + ( slot number in the frame \times numberOfSymbolsPerSlot ) + symbol number in the slot ] = [ ( {SFN}_{start time} \times numberOfSlotsPerFrame \times numberOfSymbolsPerSlot + {slot}_{start time} \times numberOfSymbolsPerSlot + {symbol}_{start time} ) + N \times periodicity ] modulo ( 1024 \times numberOfSlotsPerFrame \times numberOfSymbolsPerSlot ) .$$

The formula determines the first transmission occasion is each transmission occasion burst.

3. The ‘a length information of a duration’ is an integer indicating the number of slots or HARQ process identifiers, while ‘a valid or invalid indication’ is a bitmap. In this case, the bitmap indicates the transmission occasions. The ‘a periodicity information’ includes the periodicity of the duration. This case is for uplink configured grant or downlink SPS.

Nrofslot determines the length of a duration, while Usage determines the valid slot or HARQ process identifier in the duration.

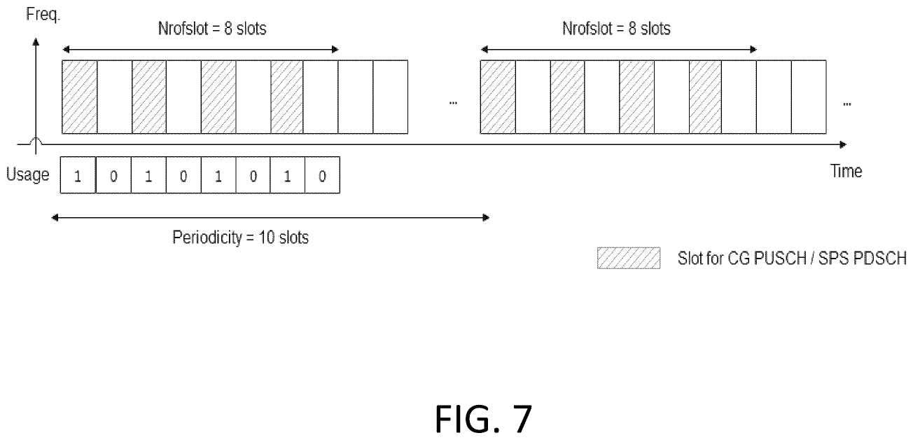

E.g., Nrofslot is set to 8. While Usage is set to ‘10101010’. And the periodicity is set to ‘sym10×14’ or ‘ms5’. The pattern is configured as illustrated in FIG. 7.

In some embodiments, the N-th transmission occasion for CG or SPS is expressed as:

$$[ ( SFN \times numberOfSlotsPerFrame ) + slot number in the frame ] = ( timeReferenceSFN \times numberOfSlotsPerFrame + timeDomainOffset + N \times periodicity ) modulo ( 1024 \times numberOfSlotsPerFrame ) or$$

$$( numberOfSlotsPerFrame \times SFN + slot number in the frame ) = [ ( numberOfSlotsPerFrame \times {SFN}_{start time} + {slot}_{start time} ) + N \times periodicity \times numberOfSlotsPerFrame / 10 ] modulo ( 1024 \times numberOfSlotsPerFrame )$$

The formula determines the first transmission occasion in each transmission occasion burst.

4. The ‘a length information of a duration’ is an integer indicating the number of slots or HARQ process identifiers, while ‘a valid or invalid indication’ is a SLIV. In this case, the SLIV determines the transmission occasions. The ‘a periodicity information’ includes the periodicity of the duration. This case is for uplink configured grant or downlink SPS.

The start and length indication value indicates the starting valid slot/HARQ Process identifier location S and the length of valid slot/HARQ Process identifier L. One of the mapping relationship between SLIV and S, L is as the followings:

```
if (L−1) ≤ NrofSlot/2 , then
  SLIV = NrofSlot ·(L−1) + S ;
else
  SLIV = NrofSlot ·(NrofSlot −L+1) + (NrofSlot −1−S);
where 0 ≤ L ≤ NrofSlot , and
```

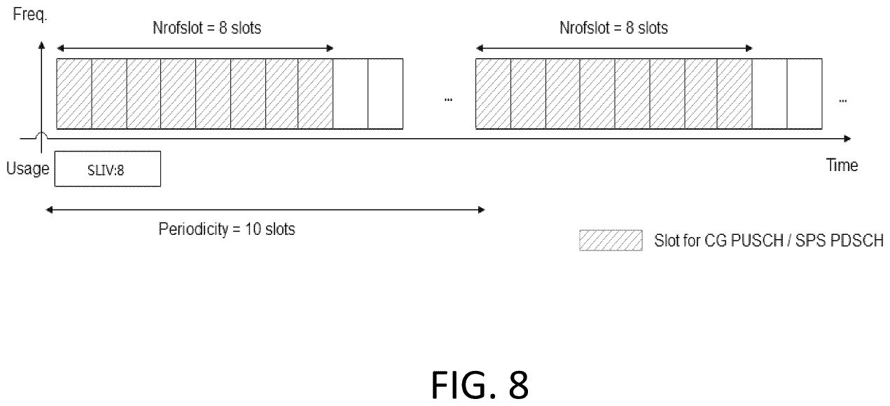

NrofSlot is set to 8. While Usage is set to 15, it means the start slot in the duration determined by NrofSlot is the first symbol of the duration and the length of valid slot is 8. And the periodicity is set to ‘sym10×14’ or ‘ms5’. The pattern is configured as illustrated in FIG. 8.

In some embodiments, the N-th transmission occasion for CG or SPS is expressed as:

$$[ ( SFN \times numberOfSlotsPerFrame ) + slot number in the frame ] = ( timeReferenceSFN \times numberOfSlotsPerFrame + timeDomainOffset + S + mod ( N , L ) + floor ( N / L ) \times periodicity ) modulo ( 1024 \times numberOfSlotsPerFrame ) . or$$

$$( numberOfSlotsPerFrame \times SFN + slot number in the frame ) = [ ( numberOfSlotsPerFrame \times {SFN}_{start time} + {slot}_{start time} + mod ( N , L ) ) + floor ( N / L ) \times periodicity \times numberOfSlotsPerFrame / 10 ] modulo ( 1024 \times numberOfSlotsPerFrame )$$

The formula determines each transmission occasion.

In some embodiments, the N-th transmission occasion for CG or SPS is expressed as:

$$[ ( SFN \times numberOfSlotsPerFrame \times numberOfSymbolsPerSlot ) + slot number in the frame ] = ( timeReferenceSFN \times numberOfSlotsPerFrame + timeDomainOffset + N \times periodicity ) modulo ( 1024 \times numberOfSlotsPerFrame ) , or$$

$$( numberOfSlotsPerFrame \times SFN + slot number in the frame ) = [ ( numberOfSlotsPerFrame \times {SFN}_{start time} + {slot}_{start time} ) + N \times periodicity \times numberOfSlotsPerFrame / 10 ] modulo ( 1024 \times numberOfSlotsPerFrame )$$

The formula determines the first transmission occasion in each transmission occasion burst.

5. The ‘a periodicity information’ includes the periodicity of duration and the periodicity of the transmission occasions in the duration. The ‘a length information of a duration’ is an integer indicating the number of symbols. This case is for uplink configured grant.

E.g., NrofSymbol determines the length of duration, while periodicity1 determines the periodicity of valid symbols in the duration.

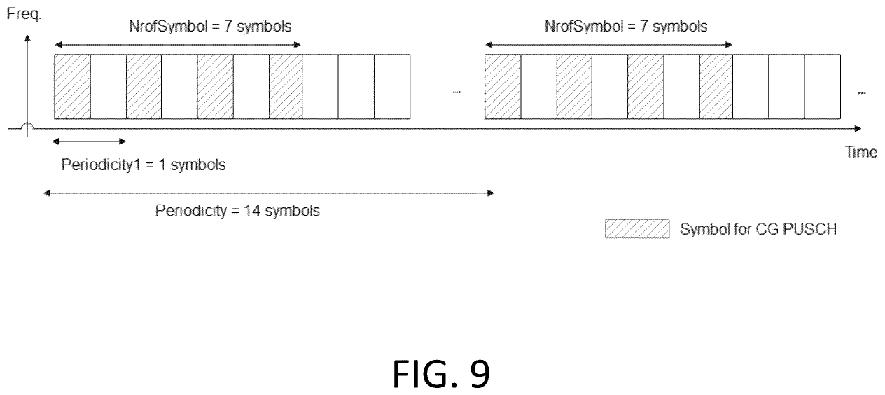

E.g., NrofSymbol is set to 7. And the periodicity is set to ‘sym1×14’ for periodicity of duration and periodicity1 is set to ‘sym1’. The pattern is configured as illustrated in FIG. 9.

In some embodiments, the N-th transmission occasion for CG is expressed as:

$$[ ( SFN \times numberOfSlotsPerFrame \times numberOfSymbolsPerSlot ) + ( slot number in the frame \times numberOfSymbolsPerSlot ) + symbol number in the slot ] = ( timeReferenceSFN \times numberOfSlotsPerFrame \times numberOfSymbolsPerSlot + timeDomainOffset \times numberOfSymbolsPerSlot + S + ( mod ( N , P ) * periodicity1 ) + floor ( N / P ) \times periodicity ) modulo ( 1024 \times numberOfSlotsPerFrame \times numberOfSymbolsPerSlot ) or$$

$$( numberOfSlotsPerFrame \times SFN + slot number in the frame ) = [ ( numberOfSlotsPerFrame \times {SFN}_{start time} + {slot}_{start time} + ( mod ( N , P ) * periodicity 1 ) ) + floor ( N / P ) \times periodicity \times numberOfSlotsPerFrame / 10 ] modulo ( 1024 \times numberOfSlotsPerFrame )$$

$$P = ceil ( NrofSymbol / periodicity 1 )$$

6. The ‘a periodicity information’ includes the periodicity of duration and the periodicity of the transmission occasions in the duration. The ‘a length information of a duration’ is an integer indicating the number of slots/HARQ Process identifiers. This case is for uplink configured grant or downlink SPS.

E.g., NrofSlot determines the length of duration, while periodicity1 determines the periodicity of valid slots/HARQ process identifier in the duration.

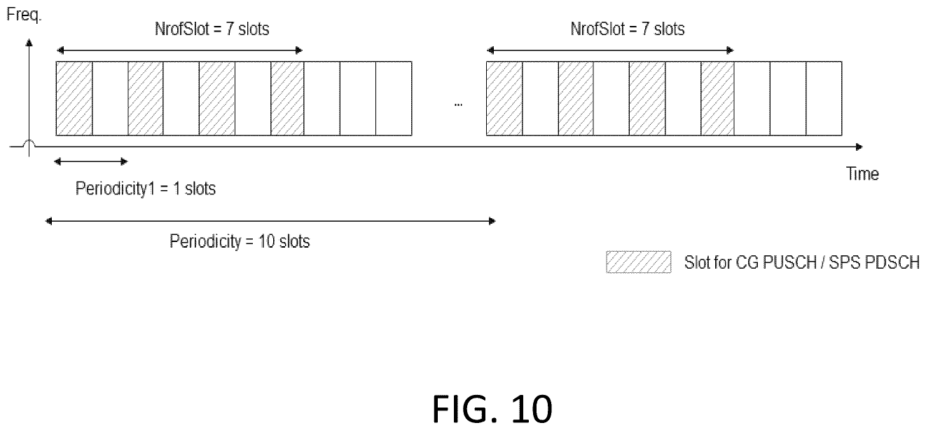

E.g., NrofSlot is set to 7. And the periodicity is set to ‘10×sym14’ or ‘ms5’ for periodicity of duration and periodicity1 is set to ‘sym14’ or ‘ms0.5’. The pattern is configured as illustrated in FIG. 10.

In some embodiments, the N-th transmission occasion for CG/SPS is expressed as:

$$( numberOfSlotsPerFrame \times SFN + slot numbe r in the frame ) = [ ( numberOfSlotsPerFrame \times {SFN}_{start time} + ( {slot}_{start time} + ( mod ( N , P ) ) * periodicity1 ) + ( floor ( N / P ) \times periodicity \times numberOfSlotsPerFrame / 10 ] modulo ( 1024 \times numberOfSlotsPerFrame )$$

$$P = ceil ( NrofSlot / periodicity1 )$$

The formula determines each transmission occasion.

In some embodiments, the periodicity is a rounded result in above formula for transmission occasion calculation for aligning the periodicity of the service with non-integer periodicity. In some cases, the rounded result is the result after floor, round or ceiling operation.

For example, if the periodicity of service is 16.67 ms, the rounded periodicity is 16 ms or 17 ms. If a slot is 0.5 ms, the periodicity in formula is 32 slots or 34 slots.

In some embodiments, the number information of the configurations determines the number of the configurations in a group to configure the one or more transmission occasions.

In some embodiments, the configuration set comprises one or more configurations, and the number of configurations is associated with number information of configurations, wherein the configurations comprise one or more transmission occasions.

In some embodiments, the configuration set includes a group of configurations used to configure the transmission occasions. In some cases, the configuration set includes one or more configurations.

The first information includes ‘a number information of configurations’ and ‘a periodicity information’, wherein ‘a periodicity information’ includes the periodicity of configurations and offset/interval between configurations. This case is for uplink CG or downlink SPS.

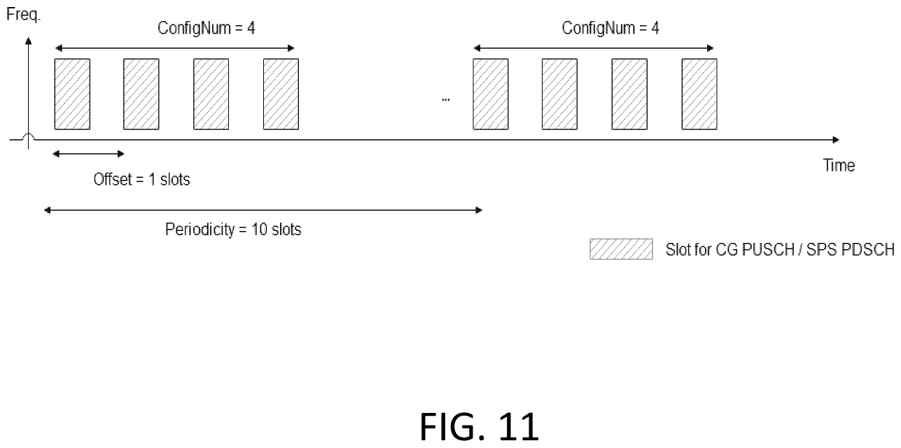

E.g., ‘a number information of configurations’ is an integer indicated by ConfigNum. In the example, as illustrated in FIG. 11, ConfigNum=4, the periodicity of each configuration is ‘10×sym14’ or ‘ms5’, while the offset of different periodicity is ‘sym14’ or ‘ms0.5’.

The configurations used for the above pattern belongs to a configuration set.

In some embodiments, the offset/interval is associated with ‘a number information of configurations’, in order to align the periodicity of service with non-integer periodicity.

In some embodiments, the configuration set includes a group of configurations with a same index. For example, the number of the configurations for the configured pattern is 4. The configuration set is (1, 1, 1, 1), . . . , (15, 15, 15, 15).

The configuration set is the repetition of a certain configuration. For example, there are total 16 configurations, which is indexing from 0 to 15. And the ‘a number information of configurations’ (e.g., ConfigNum) is set to 4. Then there are 16 CG sets.

E.g., CG set 0: {0, 0, 0, 0} for repeating 4 CG configuration with index 0.

CG set 15: {15, 15, 15, 15} for repeating 4 CG configuration with index 15.

In some embodiments, the configuration set comprises a group of configurations with different indices. For example, there are 16 configurations in total (i.e., configurations 0 to 15), the number of the configurations for the configured pattern is 4. The configuration set are, for example, set1 (configurations 0 to 3), set2 (configurations 4 to 7), set3 (configurations 8 to 11), and set4 (configurations 12 to 15).

The configuration set is the grouping of some configurations. For example, there are 16 CG configurations, which is indexing from 0 to 15. And the ‘a number information of configurations’ is set to 4. Then there are 4 CG sets.

E.g., CG set 0: {0, 1, 2, 3} for grouping 4 CG configurations from index 0 to index 3.

CG set 4: {12, 13, 14, 15} for grouping 4 CG configurations from index 12 to index 15.

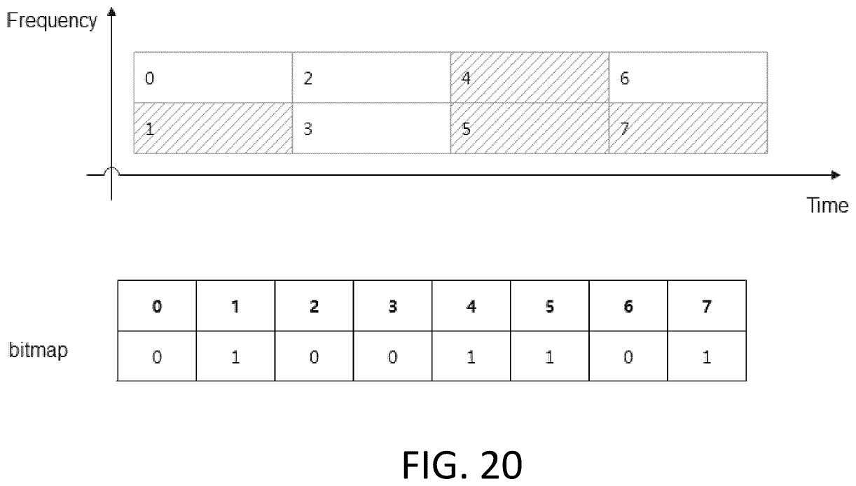

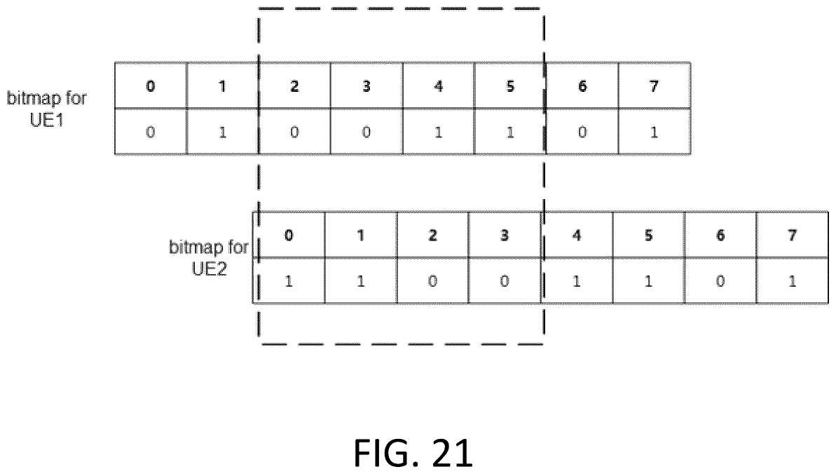

In some embodiments, a first information is a number of a scheduled resource. In this case, the bitmap or SLIV indicates scheduled resource, and the scheduled resource is a time-frequency resource includes a part of a bandwidth (e.g., a half of the bandwidth) of a symbol, slot, HARQ process identifier, a resource block, or a resource block group in the periodic duration is used. As shown in FIG. 20 and FIG. 21, the scheduled resource is indicated by a bitmap.

In some embodiments, the length of bitmap or the maximum of SLIV is determined by high layer parameter, while the effect time of bitmap or SLIV is determined by high layer parameter, e.g., RRC signaling. The effect time of bitmap or SLIV means the bitmap is available after K slots/symbols when it is received. The bitmap or SLIV is transmitted by physical layer signaling, e.g., DCI format 2_6.

In some embodiments, the first set of information comprises second information for determining a time domain resource assignment for one or more transmission occasions, and the second information comprises at least one of: time domain information of a first transmission occasion of the transmission occasions in the duration; and/or time domain information of the transmission occasions in the duration.

In some embodiments, the second information is time domain information of the first transmission occasion of the transmission occasions in the duration, and the time domain information of remaining transmission occasions in the duration is determined by the first transmission occasion.

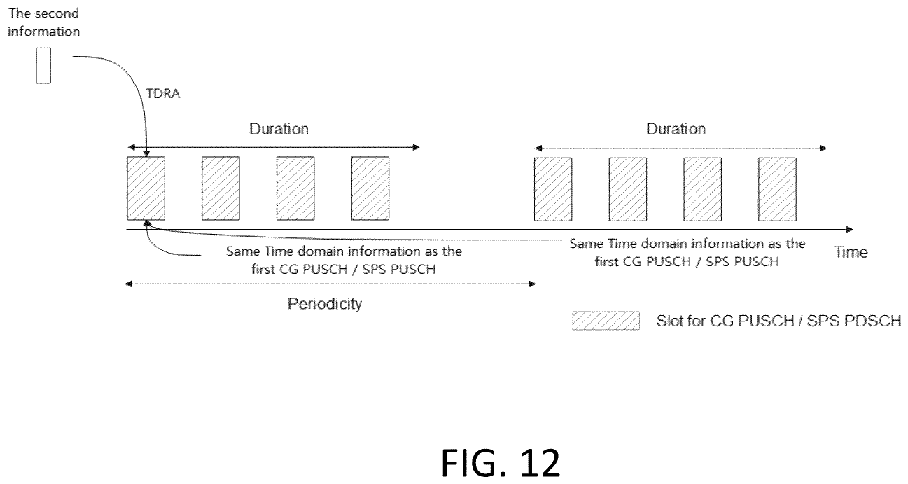

In some embodiments, as illustrated in FIG. 12, all transmission occasions use the same SLIV as the first transmission occasion.

In some embodiments, the second information is time domain information of the transmission occasions in the duration, and the time domain information is at least one of: one or more time domain pattern identifiers, wherein a time domain pattern comprises one or more SLIVs.

In some embodiments, one of the time domain pattern identifiers indicates the time domain information of the transmission occasions in the duration.

SLIV is used for time domain assignment, which includes the starting symbol location S and the length of symbols L in a transmission occasion. The relationship between SLIV, S, and L is as the following:

```
if (L−1) ≤ 7, then
  SLIV =14·(L−1)+S ;
else
  SLIV =14·(14−L+1)+(14−1−S) ;
    where0<L≤14−S .
```

A SLIV pattern contains SLIVs for the transmission occasions in the duration. In this case, there is a time domain assignment pool in RRC signaling, e.g. ConfiguredGrantConfig or SPS-config. And the time domain assignment pattern in the time domain assignment pool is for the transmission occasions in one duration. The second information indicates the index of a time domain pattern. When the second information is received, the time domain pattern is selected and time domain assignment for transmission occasions in duration are configured according to the time domain pattern.

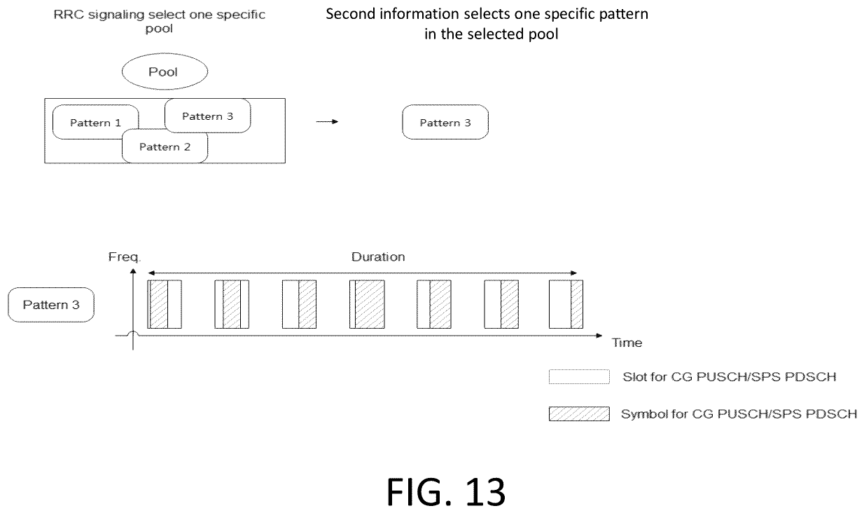

For example, in FIG. 13, the second information is indicated by 3. And the pattern 3 includes 7 SLIVs for corresponding transmission occasions, where the pattern is {25, 56, 57, 124, 58, 54, 26}. The value ‘57’ corresponds to the third transmission occasion in the duration, and it is decoded as S=1, L=5, which means the time domain assignment of the third transmission occasion is from the second symbol to the sixth symbol (assuming the counting of the symbols starts from 0).

In some embodiments, the SLIVs of the transmission occasions at both ends of the duration is smaller than the SLIV of transmission in the middle of the periodic duration.

In some embodiments, one of the time domain pattern identifiers indicates the time domain information of one of the transmission occasions in the duration.

A SLIV pattern contains a SLIV for single transmission occasion in the duration. In some embodiments, M SLIVs patterns respectively determine M transmission occasions within the duration, and M is an integer.

In this case, there is a time domain assignment pool in RRC signaling, e.g. ConfiguredGrantConfig or SPS-config. And the time domain assignment pattern in the time domain assignment pool is for the single transmission occasion. The second information indicates several indices for the transmission occasions in the duration, implying the length of second information is relevant to first information (The length information of the duration). When second information is received, the time domain information for transmission occasions in the duration are configured.

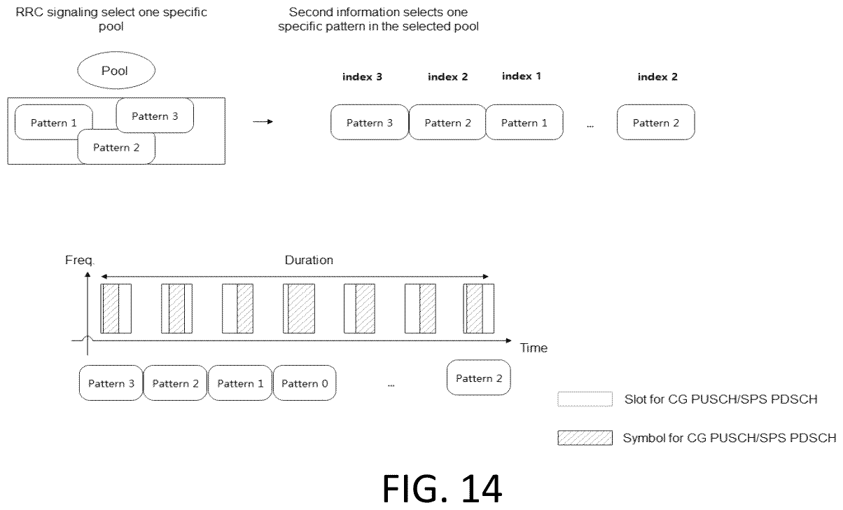

For example, in FIG. 14, the second information is ‘index 3, index 2, index 1, index 0, index 5, index 1, index 2’, which corresponds to the transmission occasion in duration. Each index corresponds to a SLIV. For instance, ‘Index 0’ corresponds to SLIV=101, the value ‘101’ is decoded as S=3, L=8, which means that the time domain assignment for the fourth transmission occasion in the duration is from the fourth symbol to the eleventh symbol (assuming the counting of the symbols starts from 0).

In some embodiments, the first set of information comprises third information for determining a frequency domain resource assignment for one or more transmission occasions, and the third information comprises at least one of: frequency domain information of a first transmission occasion of the transmission occasions in the duration; or frequency domain information of the transmission occasions in the duration.

In some embodiments, the third information is frequency domain information of the first transmission occasion of the transmission occasions in the duration, and the frequency domain information of remaining transmission occasions in the duration is determined by the first transmission occasion.

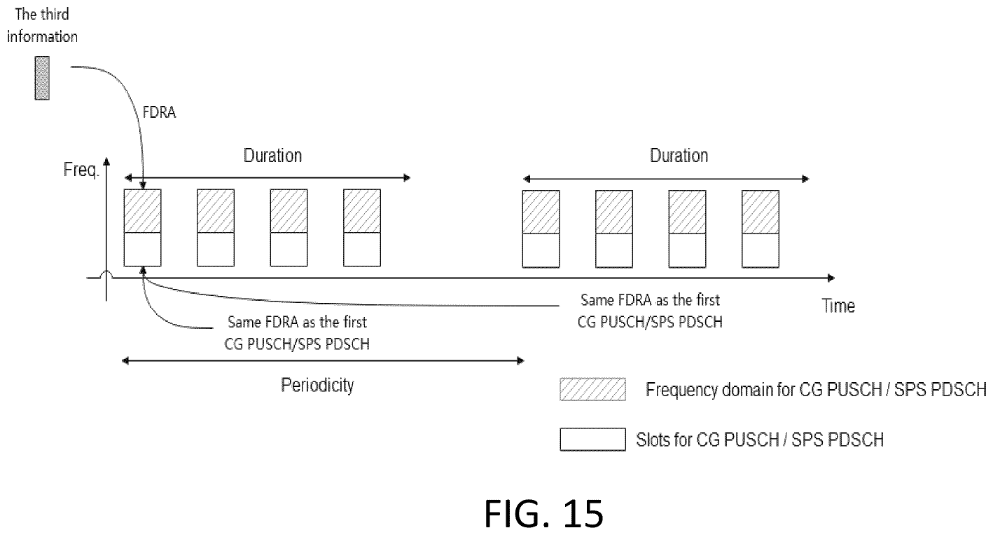

For example, in the embodiment corresponding to FIG. 15, all the transmission occasion use the same frequency domain information as the frequency domain of the first transmission occasion. The type of frequency domain information is bitmap or Resource Indicator Value, RIV.

In some embodiments, the third information is frequency domain information of the transmission occasions in the duration, and the frequency domain information is at least one of: one or more frequency domain pattern identifiers, wherein a frequency domain pattern comprises one or more Resource Indicator Values, RIVs.

In some embodiments, one of the frequency domain pattern identifiers indicates the frequency domain information of transmission occasions in the duration.

RIV is used for time domain assignment, which includes the starting virtual resource block RBₛₜₐᵣₜ and the length of virtual resource block L_{RBs} in a transmission occasion. The relationship between RIV and RBₛₜₐᵣₜ, and L_{RBs} is as the following:

```
if (L_{RBs} −1)≤└N_{BWP}^{size}/2┘ , then
  RIV=N_{BWP}^{size}(L_{RBs} −1) + RBₛₜₐᵣₜ;
else
  RIV=N_{BWP}^{size}(N_{BWP}^{size}−L_{RBs} +1) + (N_{BWP}^{size}−1−RBₛₜₐᵣₜ);
```

where L_{RBs}>1 and shall not exceed N_{BWP}^{size}−RBₛₜₐᵣₜ.

A RIV pattern contains RIVs for transmission occasions in the duration. In this case, there is a frequency domain assignment pool in RRC signaling, e.g., ConfiguredGrantConfig or SPS-config. And the frequency domain assignment pattern in the frequency domain assignment pool is for the transmission occasions in one duration. The third information indicates the index of a frequency domain pattern. When the third information is received, the frequency domain pattern is selected and frequency domain assignment for transmission occasions in duration are configured according to the frequency domain pattern.

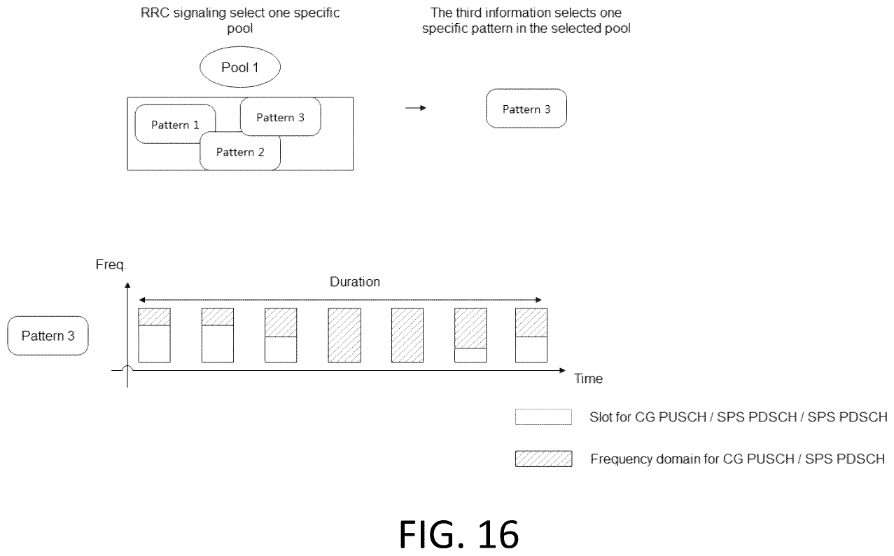

For example, in FIG. 16, the third information is indicated by 3. Assuming there are 50 virtual RBs in the active bandwidth part, the pattern 3 includes 7 RIVs for corresponding transmission occasions, where the pattern is {101, 156, 157, 201, 158, 154, 126}. The value ‘201’ corresponds to the fourth transmission occasion in the duration, and it is decoded as Start=1, Length=5, which means the frequency domain assignment of the fourth transmission occasion is from the second virtual RB to the sixth virtual RB (assuming the counting of the virtual RBs starts from 0).

In some embodiments, the RIVs of the transmission occasion at both ends of the duration is smaller than the RIV of transmission in the middle of the periodic duration.

In some embodiments, one of the frequency domain pattern identifiers indicates the time domain information of one of the transmission occasions in the duration.

A RIV pattern contains a RIV for single transmission occasion in the duration. In some embodiments, M RIVs patterns respectively determine M transmission occasions within the periodic duration, and M is an integer.

In this case, there is a frequency domain assignment pool in RRC signaling, e.g. ConfiguredGrantConfig or SPS-config. And the frequency domain assignment pattern in the frequency domain assignment pool is for the single transmission occasion. The third information indicates several indices for the transmission occasions in the duration, implying the length of third information is relevant to first information (The length information of the duration). When third information is received, the frequency domain information for transmission occasions in the duration are configured.

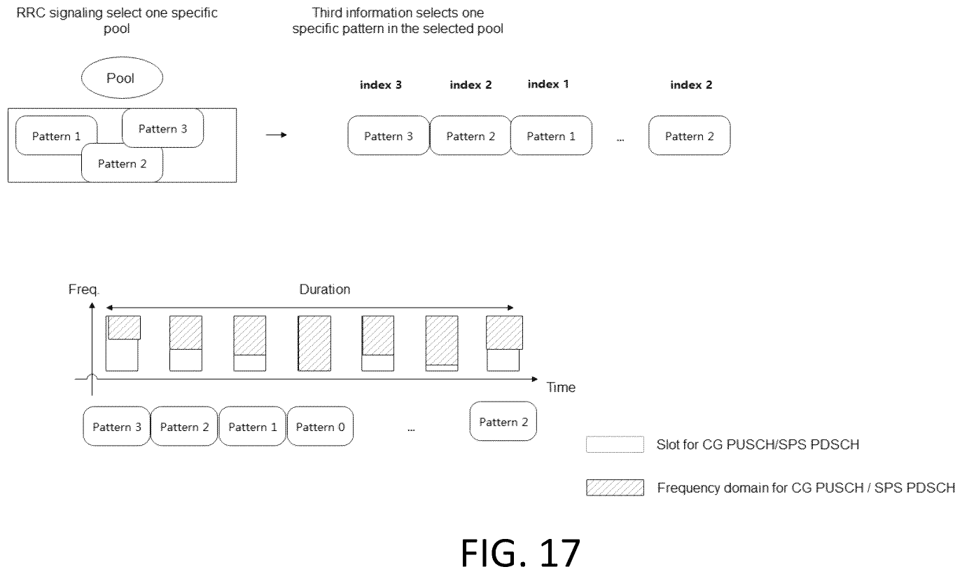

For example, in FIG. 17, the third information is ‘index 3, index 2, index 1, index 0, index 5, index 4, index 2’, which corresponds to the transmission occasion in duration. Each index corresponds to a RIV. Assuming there are 50 virtual RBs in the active bandwidth part, ‘Index 2’ corresponds to RIV=101, the value ‘101’ is decoded as Start=1, Length=3, which means that the frequency domain assignment for the second transmission occasion in the duration is from the second virtual RB to the fourth virtual RB (assuming the counting of the virtual RB starts from 0).

In some embodiments, the first set of information comprises fourth information for determining a modulation and coding scheme level for one or more transmission occasions, and the fourth information comprises at least one of: modulation and coding scheme (MCS) tables; an MCS level; and/or a delta MCS level.

In some embodiments, the fourth information is the MCS level of a first transmission occasion of the transmission occasions in the duration, and the MCS level of remaining transmission occasions in the duration is determined by the first transmission occasion.

In some embodiments, the fourth information is one or more MCS levels of the transmission occasions in the duration.

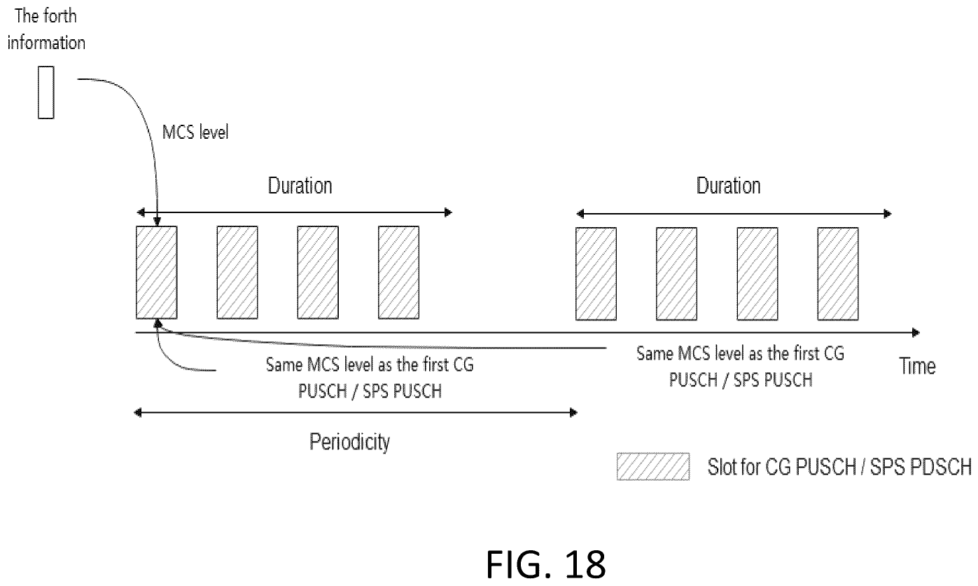

In some cases, the fourth information is one MCS levels of the first transmission occasion in the duration. All transmission occasions use the same MCS levels as that of the first transmission occasion (e.g., see FIG. 18).

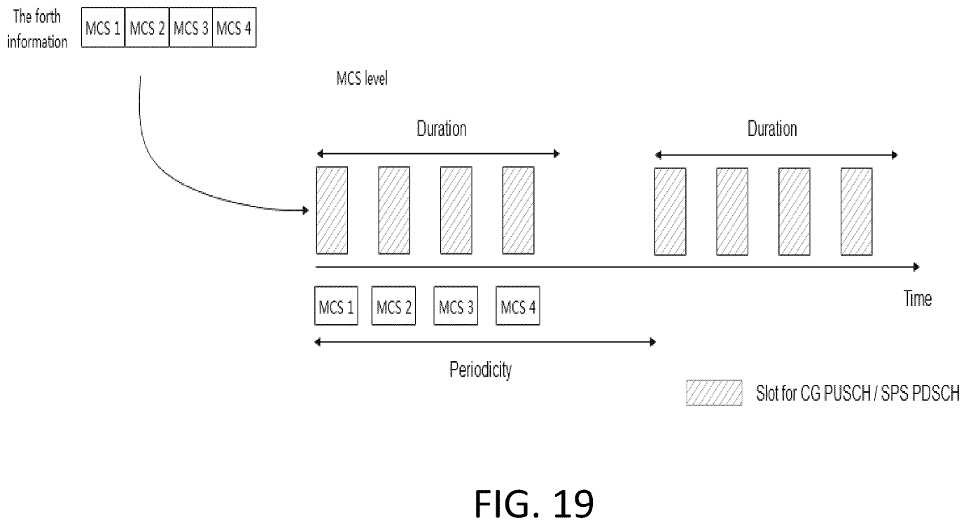

In some cases, the fourth information is multiple MCS levels of the transmission occasions in the duration (e.g., see FIG. 19).

For example, there are four transmission occasions in the duration. The fourth information includes four MCS levels corresponding to the 4 transmission occasions, respectively. For instance, ‘MCS 1’ is for the first transmission occasion.

In some embodiments, the delta MCS level is associated with an MCS level of a first transmission occasion, or an MCS level of a former transmission occasion.

In some embodiment, the MCS level is adjusted according to the current transmission condition. The current transmission is determined by the parameter N and M. N is the times of successive successful transmission, which M is the times of the successive failure transmission, where N and M is configured in RRC signaling, MAC CE or DCI signaling. If times of successive successful transmission is larger than N, the MCS level is enhanced to fit the good channel condition. While if the time of successive failure transmission is large than M, the MCS level is decreased to fit the poor channel condition.

Moreover, the MCS level is adjusted by delta MCS information. The delta MCS information is carried by DCI signaling, including e.g., UE specific DCI signaling (DCI format 1_0/1_1/1_2 for SPS or, DCI format 0_0/0_1/0_2 for CG), Group common DCI signaling (DCI format 2_6). The periodicity of DCI signaling carrying delta MCS information.

Delta MCS information including at least one of the followings:
2 states to indicate the direction of MCS adjustment. E.g. bit ‘1’ represents the MCS level is increase by X while bit ‘0’ represents the MCS level is decreased by X. The step granularity X of MCS adjustment can be determined by RRC signaling.

| Values | Description |
|---|---|
| ‘1’ | Increase MCS level |
| ‘0’ | Decrease MCS level |

K states to indicate the value of MCS adjustment. The steps of MCS adjustment is determined by RRC signaling.

E.g., RRC determines the delta MCS values are ‘−2’, ‘−1’, ‘0’, ‘+1’, respectively. The delta MCS information is 2-bit length, where ‘00’ denotes value ‘0’, ‘11’ denotes value ‘−2’, ‘10’ denotes value ‘−1’ and ‘01’ denotes value ‘1’.

| Values | Description |
|---|---|
| ‘11’ | Decrease MCS level by 2 |
| ‘10’ | Decrease MCS level by 1 |
| ‘01’ | Increase MCS level by 1 |
| ‘00’ | Remain current MCS level |

E.g., RRC determines the number of states is 4 and the step granularity of the delta MCS values is 2. The delta MCS values are derived to ‘−4’, ‘−2’, ‘0’, ‘+2’, respectively. The length of delta MCS information is determined by the number of states, where ‘00’ denotes value ‘0’, ‘11’ denotes value ‘−4’, ‘10’ denotes value ‘−2’ and ‘01’ denotes value ‘+2’.

In some embodiments, the first set of information comprises fifth information for determining activations of one or more transmission occasions, and the fifth information comprises at least one of: an activation indication, an activation type indication, a configuration set identifier, or a configuration identifier.

In some embodiments, the configuration set identifier determines which configuration set is activated.

In some embodiments, when the multiple transmission occasions are configured, one transmission occasion in the duration may not be able to be configured. A configuration of multiple transmission occasions can be identified through the first information, such as ‘a length information of a duration’.

For example, for the pattern in FIG. 3 or FIG. 4 is configured, the pattern in FIG. 1 or FIG. 2 is not able to be configured.

In some embodiments, the activation type indication determines the fifth information is for one transmission occasion activation (pattern in FIG. 1 or FIG. 2) or multiple transmission occasion activation (pattern in FIG. 3 or FIG. 4), and the activation type indication comprises at least one of: a bit flag, a re-interpreted information field, a configuration index, or an interval between the control signal and a first transmission occasion.

In some embodiments, the activation type indication indicates the activation indication is for the multiple scheduled resources in response to a slot interval between the activations and a first transmission occasion of the uplink or downlink data being less than a predetermined time threshold. For example, if the slot interval between the activation and the first transmission occasion is less than N slots or symbols, the activation is for multiple transmission occasions, in which N is an integer.

In some embodiments, the activation type indication includes a bit flag indicating the activation indication is for the multiple transmission occasions or for the one transmission occasion. The indication is a specific DCI field with 1-bit length. The addition bit flag is the reserved bit or re-interpretation of existing DCI signaling or the field of new DCI format. Bit flag ‘1’ indicates the activation signaling is for multiple transmission occasions, while bit flag ‘0’ indicates the activation signaling is for one transmission occasion.

In some embodiments, the activation type indication includes a re-interpreted information field indicating the activation indication is for the multiple transmission occasions.

The field is reused to indicate the type of activation signaling. For uplink transmission, the DCI signaling is DCI format 0_0, DCI format 0_1 or DCI format 0_2. For downlink transmission, the DCI signaling is DCI format 1_0, DCI format 1_1 or DCI format 1_2. The re-interpreted field is set to all ones or all zeros. The re-interpretation field includes, but not limited to, at least one of:
HARQ process number;
Redundancy version;
VRB-to-PRB mapping;
Downlink assignment index; and/or
TPC command for scheduled PUCCH.

It means that when the fields ‘HARQ process number’ and/or ‘Redundancy version’ is set to all zeros, the activation indication is for one transmission occasions. While the field VRB-to-PRB mapping, Downlink assignment index or TPC command for scheduled PUCCH is set to all zeros or all ones, the activation indication is for the multiple transmission occasions. The re-interpretation of the field is based on the predefined condition. In other words, when first information, such as ‘a length information of a duration’, is configured, the field including but not limited to VRB-to-PRB mapping, Downlink assignment index or TPC command for scheduled PUCCH is re-interpretation.

In some embodiments, the activation type indication includes a predefined configuration index indicating the activation indication is for multiple transmission occasions.

For example, if there are 16 configurations in total, which is ranging from 0 to 15. The specific index 14 and index 15 is used to indicate the activation for multiple transmission occasions.

When the field ‘HARQ process number’ is set to ‘1110’ or ‘1111’, the activation is for multiple transmission occasions.

In some embodiments, the first set of information comprises sixth information for determining deactivations of one or more transmission occasions, and the sixth information comprises at least one of: a deactivation indication, a deactivation type indication, a configuration set identifier, or a configuration identifier.

In some embodiments, the configuration set identifier determines which configuration set is deactivated.

In some embodiments, when the multiple transmission occasions are configured, the one transmission occasion may not able to be configured. A configuration of multiple transmission occasions can be identified through the first information, such as ‘a length information of a duration’.

For example, for the pattern in FIG. 3 or FIG. 4 is configured, the pattern in FIG. 1 or FIG. 2 is not able to be configured.

In some embodiments, the deactivation type indication determines the sixth information is for one transmission occasion deactivation (pattern in FIG. 1 or FIG. 2) or multiple transmission occasion deactivation (pattern in FIG. 3 or FIG. 4), and the deactivation type indication comprises at least one of: a bit flag, a re-interpreted information field, a configuration index, or an interval between the control signal and a first transmission occasion.

In some embodiments, the deactivation type indication indicates the deactivation indication is for the multiple transmission occasions in response to a slot interval between the deactivations and a first transmission occasion of the uplink or downlink data being less than a predetermined time threshold. For example, if the slot interval between the deactivation and the first transmission occasion is less than N slots or symbols, the deactivation is for multiple transmission occasions, in which N is an integer.

In some embodiments, the deactivation type indication includes a bit flag indicating the deactivation indication is for the multiple transmission occasions. For example, an additional bit flag indicates the type of deactivation signaling. The addition bit flag is the reserved bit or re-interpretation of existing DCI signaling or the field of new DCI format. Bit flag ‘1’ indicates the deactivation signaling is for multiple transmission occasions, while bit flag ‘0’ indicates the deactivation signaling is for one transmission occasion.

In some embodiments, the deactivation type indication includes a re-interpreted information field indicating the deactivation indication is for the multiple transmission occasions.

The field is reused to indicate the type of deactivation signaling. For uplink transmission, the DCI signaling is DCI format 0_0, DCI format 0_1 or DCI format 0_2. For downlink transmission, the DCI signaling is DCI format 1_0, DCI format 1_1 or DCI format 1_2. The re-interpreted field is set to all ones or all zeros. The re-interpretation field includes, but not limited to, at least one of:
HARQ process number;
Redundancy version;
Frequency domain resource assignment;
Modulation and coding scheme;
VRB-to-PRB mapping;
Downlink assignment index; and/or
TPC command for scheduled PUCCH.

It means that when the fields ‘HARQ process number’ and/or ‘Redundancy version’ are set to all zeros, as well as the fields ‘Modulation and coding scheme’, ‘Frequency domain resource assignment’ are set to all ones or all zeros, the deactivation indication is for one transmission occasions. While the field VRB-to-PRB mapping, Downlink assignment index or TPC command for scheduled PUCCH is set to all zeros or all ones, the deactivation indication is for the multiple transmission occasions. The re-interpretation of the field is based on the predefined condition. In other words, when first information, such as ‘a length information of a duration’, is configured, the field including but not limited to VRB-to-PRB mapping, Downlink assignment index or TPC command for scheduled PUCCH is re-interpretation.

In some embodiments, the deactivation type indication includes a predefined configuration index indicating the deactivation indication is for the multiple transmission occasions.

For example, if there are 16 configurations in total, which is ranging from 0 to 15. The specific index 14 and index 15 is used to indicate the deactivation for multiple transmission occasions.

When the field ‘HARQ process number’ is set to ‘1110’ or ‘1111’, the deactivation is for multiple transmission occasions.

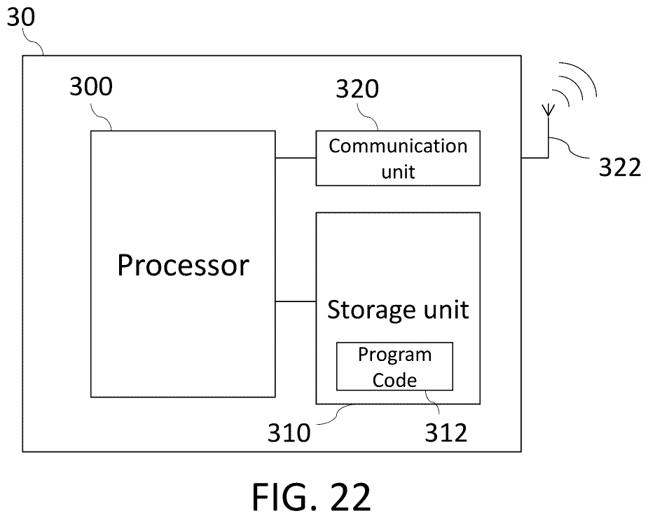

FIG. 22 relates to a schematic diagram of a wireless communication terminal 30 (e.g., a terminal node or a terminal device) according to an embodiment of the present disclosure. The wireless communication terminal 30 may be a user equipment (UE), a remote UE, a relay UE, a mobile phone, a laptop, a tablet computer, an electronic book or a portable computer system and is not limited herein. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322.

In an embodiment, the storage unit 310 and the program code 312 may be omitted and the processor 300 may include a storage unit with stored program code.

The processor 300 may implement any one of the steps in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless communication node.

In some embodiments, the wireless communication terminal 30 may be used to perform the operations of the remote UE or the relay UE described above. In some embodiments, the processor 300 and the communication unit 320 collaboratively perform the operations described above. For example, the processor 300 performs operations and transmit or receive signals, message, and/or information through the communication unit 320.

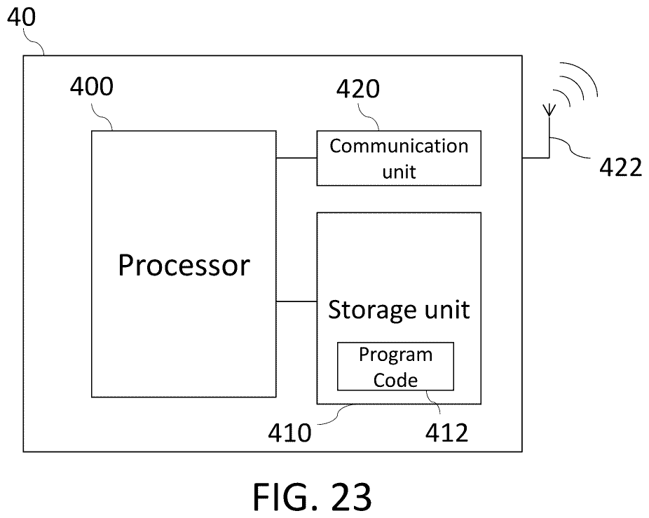

FIG. 23 relates to a schematic diagram of a wireless communication node 40 (e.g., a network device) according to an embodiment of the present disclosure. The wireless communication node 40 may be a satellite, a base station (BS), a gNB, a gNB-DU, a gNB-CU, a network entity, a Mobility Management Entity (MME), Serving Gateway (S-GW), Packet Data Network (PDN) Gateway (P-GW), a radio access network (RAN), a next generation RAN (NG-RAN), a data network, a core network or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), etc. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422.

In an embodiment, the storage unit 410 and the program code 412 may be omitted. The processor 400 may include a storage unit with stored program code.

The processor 400 may implement any steps described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from a wireless communication node or a wireless communication terminal.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method comprising:
receiving, by a wireless communication terminal from a wireless communication node, a control signaling;
determining, by the wireless communication terminal, a first set of information according to the control signaling,
wherein in case the control signaling is a radio resource control (RRC) signaling, a first information, a second information, a third information and a fourth information in the first set of information are determined by the RRC signaling, and a first transmission occasion in an N-th transmission occasion burst is calculated by a first formula, or in case the control signaling is the RRC signaling and a download control information (DCI) signaling, the first information, the second information, the third information and the fourth information in the first set of information are determined by the RRC signaling and the DCI signaling, and the first transmission occasion in the N-th transmission occasion burst is calculated by a second formula, wherein the first information comprises: a length information of a duration, the length information comprising a number of slots; and a periodicity information, the periodicity information comprising a periodicity of the transmission occasions in the duration determined by the length information of a duration in the first information, and the periodicity of the transmission occasions being 14 symbols, and wherein the second information is for determining a time domain resource assignment for one or more transmission occasions, the third information is for determining a frequency domain resource assignment for one or more transmission occasions, and the fourth information is for determining a modulation and coding scheme (MCS) level for one or more transmission occasions; and
performing, by the wireless communication terminal, a transmission of uplink data based on transmission occasions according to the first set of information.

2. The wireless communication method of claim 1, wherein the length information is 7 or 8 slots.

3. The wireless communication method of claim 1, wherein the second information comprises a time domain information of the first transmission occasion of the transmission occasions in the duration, a time domain information of remaining transmission occasions in the duration is determined by the first transmission occasion, the transmission occasions having identical start and length Indicator value (SLIV) for the first transmission occasion, and the SLIV comprising a starting symbol location and a length of symbols in a transmission occasion.

4. The wireless communication method of claim 1, wherein the third information is a frequency domain information of the first transmission occasion of the transmission occasions in the duration, a frequency domain information of remaining transmission occasions in the duration being determined by the first transmission occasion, and wherein the remaining transmission occasions in the duration use the same frequency domain information as the frequency domain information of the first transmission occasion in the duration.

5. The wireless communication method of claim 1, wherein the fourth information is the MCS level of the first transmission occasion of the transmission occasions in the duration, and the MCS level of remaining transmission occasions in the duration being determined by the first transmission occasion, and wherein the remaining transmission occasions in the duration use the same MCS level as the MCS level of the first transmission occasion in the duration.

6. The wireless communication method of claim 1, wherein the first formula comprises:
[(SFN×numberOfSlotsPerFrame×numberOfSymbolsPerSlot)+(slot number in the frame×numberOfSymbolsPerSlot)+symbol number in the slot]=(timeReferenceSFN×numberOfSlotsPerFrame×numberOfSymbolsPerSlot+timeDomainOffset×numberOfSymbolsPerSlot+S+N×periodicity) modulo (1024×numberOfSlotsPerFrame×numberOfSymbolsPerSlot), and
wherein S is a start symbol location of the duration, timeDomainOffset denotes offset of a resource with respect to SFN=timeReferenceSFN in time domain, timeReferenceSFN is SFN used for determination of the offset of a resource in time domain, numberOfSlotsPerFrame denotes the number of slots in per radio frame, numberOfSymbolsPerSlot denotes a number of symbols in per slot, and periodicity is a periodicity of a configured grant.

7. The wireless communication method of claim 1, wherein the second formula comprises:
[(SFN×numberOfSlotsPerFrame×numberOfSymbolsPerSlot)+(slot number in the frame×numberOfSymbolsPerSlot)+symbol number in the slot]=[(SFNstart time×numberOfSlotsPerFrame×numberOfSymbolsPerSlot+slotstart time×numberOfSymbolsPerSlot+symbolstarttime)+N×periodicity] modulo (1024×numberOfSlotsPerFrame×numberOfSymbolsPerSlot), and
wherein numberOfSlotsPerFrame denotes the number of slots in per radio frame, numberOfSymbolsPerSlot denotes a number of symbols in per slot, and periodicity is a periodicity of a configured grant.

8. A wireless communication method comprising: transmitting, by a wireless communication node to a wireless communication terminal, a control signaling to allow the wireless communication terminal to determine a first set of information according to the control signaling and to perform a transmission of uplink data based on transmission occasions according to the first set of information,
wherein in case the control signaling is a radio resource control (RRC) signaling, a first information, a second information, a third information and a fourth information in the first set of information are determined by the RRC signaling, and a first transmission occasion in an N-th transmission occasion burst is calculated by a first formula, or in case the control signaling is the RRC signaling and a downlink control information (DCI) signaling, the first information, the second information, the third information and the fourth information in the first set of information are determined by the RRC signaling and the DCI signaling, and the first transmission occasion in the N-th transmission occasion burst is calculated by a second formula,
wherein the first information comprises: a length information of a duration, the length information comprising a number of slots; and a periodicity information, the periodicity information comprising a periodicity of the transmission occasions in the duration determined by the length information of a duration in the first information, and the periodicity of the transmission occasions being 14 symbols, and
wherein the second information is for determining a time domain resource assignment for one or more transmission occasions, the third information is for determining a frequency domain resource assignment for one or more transmission occasions, and the fourth information is for determining a modulation and coding scheme (MCS) level for one or more transmission occasions.

9. The wireless communication method of claim 8, wherein the length information is 7 or 8 slots.

10. The wireless communication method of claim 8, wherein the second information comprises a time domain information of the first transmission occasion of the transmission occasions in the duration, a time domain information of remaining transmission occasions in the duration is determined by the first transmission occasion, the transmission occasions having identical start and length Indicator value (SLIV) for the first transmission occasion, and the SLIV comprising a starting symbol location and a length of symbols in a transmission occasion.

11. The wireless communication method of claim 8, wherein the third information is a frequency domain information of the first transmission occasion of the transmission occasions in the duration, a frequency domain information of remaining transmission occasions in the duration being determined by the first transmission occasion, and wherein the remaining transmission occasions in the duration use the same frequency domain information as the frequency domain information of the first transmission occasion in the duration.

12. The wireless communication method of claim 8, wherein the fourth information is the MCS level of the first transmission occasion of the transmission occasions in the duration, and the MCS level of remaining transmission occasions in the duration being determined by the first transmission occasion, and wherein the remaining transmission occasions in the duration use the same MCS level as the MCS level of the first transmission occasion in the duration.

13. The wireless communication method of claim 8, wherein the first formula comprises:
[(SFN×numberOfSlotsPerFrame×numberOfSymbolsPerSlot)+(slot number in the frame×numberOfSymbolsPerSlot)+symbol number in the slot]=(timeReferenceSFN×numberOfSlotsPerFrame×numberOfSymbolsPerSlot+timeDomainOffset×numberOfSymbolsPerSlot+S+N×periodicity) modulo (1024×numberOfSlotsPerFrame×numberOfSymbolsPerSlot), and
wherein S is a start symbol location of the duration, timeDomainOffset denotes offset of a resource with respect to SFN=timeReferenceSFN in time domain, timeReferenceSFN is SFN used for determination of the offset of a resource in time domain, numberOfSlotsPerFrame denotes the number of slots in per radio frame, numberOfSymbolsPerSlot denotes a number of symbols in per slot, and periodicity is a periodicity of a configured grant.

14. The wireless communication method of claim 8, wherein the second formula comprises:
[(SFN×numberOfSlotsPerFrame×numberOfSymbolsPerSlot)+(slot number in the frame×numberOfSymbolsPerSlot)+symbol number in the slot]=[(SFNstart time×numberOfSlotsPerFrame×numberOfSymbolsPerSlot+slotstart time×numberOfSymbolsPerSlot+symbolstat time)+N×periodicity] modulo (1024×numberOfSlotsPerFrame×numberOfSymbolsPerSlot), and
wherein numberOfSlotsPerFrame denotes the number of slots in per radio frame, numberOfSymbolsPerSlot denotes a number of symbols in per slot, and periodicity is a periodicity of a configured grant.

15. A wireless communication terminal, comprising:
a communication unit; and
a processor configured to:
receive, via the communication unit from a wireless communication node, a control signaling;
determine a first set of information according to the control signaling,
wherein in case the control signaling is a radio resource control (RRC) signaling, a first information, a second information, a third information and a fourth information in the first set of information are determined by the RRC signaling, and a first transmission occasion in an N-th transmission occasion burst is calculated by a first formula, or in case the control signaling is the RRC signaling and a downlink control information (DCI) signaling, the first information, the second information, the third information and the fourth information in the first set of information are determined by the RRC signaling and the DCI signaling, and the first transmission occasion in the N-th transmission occasion burst is calculated by a second formula,
wherein the first information comprises: a length information of a duration, the length information comprising a number of slots; and a periodicity information, the periodicity information comprising a periodicity of the transmission occasions in the duration determined by the length information of a duration in the first information, and the periodicity of the transmission occasions being 14 symbols, and wherein the second information is for determining a time domain resource assignment for one or more transmission occasions, the third information is for determining a frequency domain resource assignment for one or more transmission occasions, and the fourth information is for determining a modulation and coding scheme (MCS) level for one or more transmission occasions; and
perform a transmission of uplink data based on transmission occasions according to the first set of information.

16. The wireless communication terminal of claim 15, wherein the length information is 7 or 8 slots.

17. The wireless communication terminal of claim 15, wherein the second information comprises a time domain information of the first transmission occasion of the transmission occasions in the duration, a time domain information of remaining transmission occasions in the duration is determined by the first transmission occasion, the transmission occasions having identical start and length Indicator value (SLIV) for the first transmission occasion, and the SLIV comprising a starting symbol location and a length of symbols in a transmission occasion.

18. The wireless communication terminal of claim 15, wherein the third information is a frequency domain information of the first transmission occasion of the transmission occasions in the duration, a frequency domain information of remaining transmission occasions in the duration being determined by the first transmission occasion, and wherein the remaining transmission occasions in the duration use the same frequency domain information as the frequency domain information of the first transmission occasion in the duration.

19. The wireless communication terminal of claim 15, wherein the fourth information is the MCS level of the first transmission occasion of the transmission occasions in the duration, and the MCS level of remaining transmission occasions in the duration being determined by the first transmission occasion, and wherein the remaining transmission occasions in the duration use the same MCS level as the MCS level of the first transmission occasion in the duration.

20. The wireless communication terminal of claim 15, wherein the first formula comprises:
[(SFN×numberOfSlotsPerFrame×numberOfSymbolsPerSlot)+(slot number in the frame×numberOfSymbolsPerSlot)+symbol number in the slot]=(timeReferenceSFN×numberOfSlotsPerFrame×numberOfSymbolsPerSlot+timeDomainOffset×numberOfSymbolsPerSlot+S+N×periodicity) modulo (1024×numberOfSlotsPerFrame×numberOfSymbolsPerSlot), and
wherein S is a start symbol location of the duration, timeDomainOffset denotes offset of a resource with respect to SFN=timeReferenceSFN in time domain, timeReferenceSFN is SFN used for determination of the offset of a resource in time domain, numberOfSlotsPerFrame denotes the number of slots in per radio frame, numberOfSymbolsPerSlot denotes a number of symbols in per slot, and periodicity is a periodicity of a configured grant, and/or
wherein the second formula comprises:
$$[ ( SFN \times numberOfSlotsPerFrame \times numberOfSymbolsPerSlot ) + ( slot number in the frame \times numberOfSymbolsPerSlot ) + symbol number in the slot ] = [ ( {SFN}_{start time} \times numberOfSlotsPerFrame \times numberOfSymbolsPerSlot + {slot}_{start time} \times numberOfSymbolsPerSlot + {symbol}_{start time} ) + N \times periodicity ] modulo ( 1024 \times numberOfSlotsPerFrame \times numberOfSymbolsPerSlot ) .$$
